(19) United States
(12) Patent Application Publication
(10) Pub. No.: US 2025/0371631 A1
(43) Pub. Date: Dec. 4, 2025

(54) DATA AT THE DOOR REAL ESTATE APPLICATION

(71) Applicant: Honeywell International Inc., Charlotte, NC (US)

(72) Inventors: JACKSON BEATTY, Molalla, OR (US); JAN PHILLIPS, Salem, OR (US); YENONG QI, Salem, OR (US); JONATHAN LUSH, Salem, OR (US); TOM HILL, Salem, OR (US); ALISSA D. DOOSE, Farmington, CT (US)

(21) Appl. No.: 19/306,358

(22) Filed: Aug. 21, 2025

Related U.S. Application Data
(63) Continuation of application No. 16/613,284, filed on Nov. 13, 2019, now abandoned.
(60) Provisional application No. 62/507,018, filed on May 16, 2017.

(51) Int. Cl. G06Q 50/16; G06Q 10/10; H04W 4/02; H04W 4/30

(52) U.S. Cl. CPC G06Q 50/16; G06Q 10/10; H04W 4/023; H04W 4/30

(57) ABSTRACT

Methods and systems for communicating data for a subject real estate listing. The system is configured for, or the method includes receiving a showing note regarding a subject real estate listing; storing the showing note; and, responsive to a mobile or handheld device interacting with or being present at a real estate property, communicating the showing note to a handheld device operating a data at the door application.

### CROSS-REFERENCE TO RELATED APPLICATION

This application is a continuation of U.S. patent application Ser. No. 16/613,284, filed Nov. 13, 2019, which is a 371 international application of Patent Application No. PCT/US2018/28525, filed Apr. 20, 2018, which claims the benefit of U.S. Provisional Patent Application No. 62/507,018, filed May 16, 2017, and entitled “Data At The Door Real Estate Application”, the disclosures of which are incorporated by reference herein in its entirety as if set forth at length.

### BACKGROUND

The present disclosure relates generally to a real estate communication system, and more particularly, to a system and method to provide time sensitive showing notes to a real estate agent who is showing the property.

In the real estate industry, there exists significant activity relating to the sale of a home that is decoupled from the real estate agent's knowledge. Real estate agents typically carry paper information for the subject property and don't always have up-to-date and relevant data for the subject property. Home owners also don't typically have a way to inform the real estate agent of time sensitive information concerning the property such as the dog will be in the garage the day of the showing.

### SUMMARY

A method for communicating data for a subject real estate listing according to one disclosed non-limiting embodiment of the present disclosure includes receiving a showing note regarding a subject real estate listing; storing the showing note; communicating the showing note to a handheld device operating a data at the door application.

A further aspect of the present disclosure includes time sensitive data in the showing note.

A further aspect of the present disclosure includes MLS data in the showing note.

A further aspect of the present disclosure includes data not in an MLS listing in the showing note.

A further aspect of the present disclosure includes local attractions in the showing note.

A further aspect of the present disclosure includes communicating the showing note to the handheld device operating the data at the door application in response to a proximity to the subject property.

A further aspect of the present disclosure includes communicating the showing note to the handheld device operating the data at the door application in response to accessing an electronic key box for the subject property.

A handheld device according to one disclosed non-limiting embodiment of the present disclosure includes a power supply; a memory to store executable instructions for operation of a data at the door application; a processor in communication with the memory and the power supply, the processor operable to execute the executable instructions to showing notes regarding a subject real estate listing; and a display in communication with the processor, the display configured for displaying the showing notes.

A further aspect of the present disclosure includes time sensitive data in the showing note.

A further aspect of the present disclosure includes MLS data in the showing note.

A further aspect of the present disclosure includes data not in an MLS listing in the showing note.

A further aspect of the present disclosure includes that the executable instructions include executable instructions to communicate with an electronic key box.

A further aspect of the present disclosure includes opening the data at the door application in response to communication with the electronic key box.

A further aspect of the present disclosure includes a GPS module in communication with the processor to determine a distance to the subject property.

A further aspect of the present disclosure includes opening the data at the door application in response to the handheld device coming within a predetermined distance to the subject property as determined by the GPS module.

A method for communicating data for a subject real estate listing according to one disclosed non-limiting embodiment of the present disclosure includes
receiving a showing note regarding a subject real estate listing in a data at the door application in response to a handheld device operating the data at the door application being proximate to the subject real estate listing.

A further aspect of the present disclosure includes determining a proximity to the subject real estate listing via a GPS module of the handheld device.

A further aspect of the present disclosure includes determining a proximity to the subject real estate listing via accessing an electronic key box for the subject property.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate application system.

FIG. 2 is a schematic diagram of a handheld device.

FIG. 3 is a flowchart of a method to provide communication for a real estate transaction with the system of FIG. 1.

FIG. 4 is a screenshot of the real estate application property listing view.

FIG. 5 is schematic system diagram of a portion of the real estate application system.

FIG. 6 is a flowchart of a method to obtain time sensitive information using a data at the door application.

FIG. 7 is a screenshot of the data at the door application for display on a handheld device.

FIG. 8 is a flowchart of a method of operation of the data at the door application.

### DETAILED DESCRIPTION

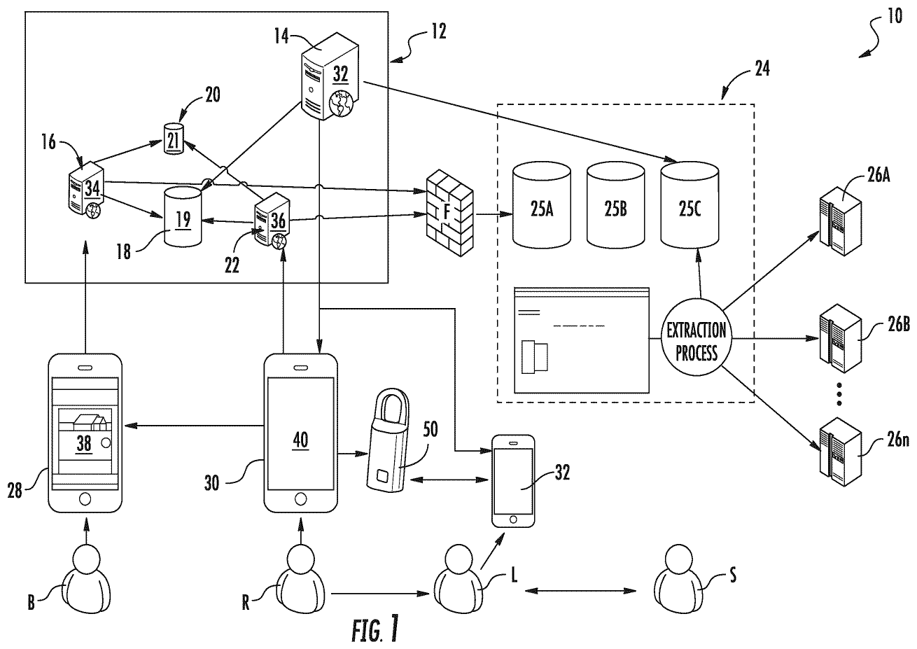

FIG. 1 schematically illustrates a system 10 to facilitate communication for real estate transactions. A showing agent “R” has a fiduciary duty to a home buyer “B” while a listing agent “L” has a fiduciary duty to a home seller “S.” The showing agent “R” typically shows the property to the home buyer “B.” The listing agent “L” typically communicates with the buyer “B” only indirectly, such as by communication with the showing agent “R” who then communicates information to and from the buyer “B.” Although only particular agents are referred to in the illustrated embodiments, the functions of such personnel may be otherwise assigned or rearranged. For example, the listing agent “L” may utilize a seller's assistant.

Showing information is accessible through the system 10 so that the listing agent “L” can generate reports for their seller “S”, send updates about a particular listing to showing agents “R” who recently showed that listing, or provide feedback from a showing. The feedback may also include data generated by an electronic key box 50 that occurs as a function of the showings, such as number of showings, time spent at the subject property, return showings, etc. Listing agents “L” may also use the system 10 to receive automatic notification (e.g., email notices) when a showing occurs at their listings. The buyer “B” may also benefit as the system 10 provides a central repository for buyer information (e.g., details of each home the buyer has viewed).

The system 10 generally includes a subsystem 12 that may be controlled by a single owner. The subsystem 12 generally includes a listing recommendation server 14, a buyer server 16, a buyer database system 18, a log database system 20, and an electronic key server 22. A multiple of handheld devices 28, 30, 32, communicate with the subsystem 12. The first handheld device 28 is herein associated with the potential buyer “B,” the second handheld device 30 is associated with the showing agent “R” and the third handheld device 32 is associated with the listing agent “L.”

“Server” conveys its customary meaning and further includes a corporate datacenter that provides service and/or data connection, e.g., to the handheld device and/or an electronic locking device. “Handheld device” refers to a portable electronic device that is at least configured to send messages to, and/or receive messages from the listing recommendation server 14 over a long-range wireless communication network, such as a SMS, wireless, or cellular network. Examples of handheld devices include, but are not limited to: a cell phone; a personal digital assistant (“PDA”); a portable computer configured to store and playback digital pictures, songs, and/or videos; and the like. In addition, the handheld device is typically also configured for short-range wireless communications.

The listing recommendation server 14 communicates with the buyer database system 18, the log database system 20, and a data center 24. The buyer database system 18 includes a database 19 that stores rating and notes taken by the buyer “B,” and the log database system 20 includes a database 21 that collects activity data. The data center 24 may host one or more servers that may include, but not be limited to, a database for managing key holders 25A, a security database 25B that hosts security protocols, and a listing database 25C that stores extracted real estate listings from external servers 26A, 26B, 26N.

The data center 24 communicates with the external data servers 26A-26N such as a Real Estate Transaction Standard (RETS) framework that stores MLS data. The MLS data includes information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The National Association of Realtors refers to RETS as a “common language.” The data center 24 may also host real estate servers including a database for managing key box inventories, a security database that houses security protocols, a listing database of property listings, and/or other databases.

The listing recommendation server 14 hosts, for example, at least an analytics software application 32 that compiles and runs analytics against buyer ratings and MLS listing data from the data center 24. The buyer server 16 hosts a buyer application program interface (API) 34, and the electronic key server 22 hosts an electronic key API 36. An application program interface (API) is a set of routines, protocols, and tools for building software applications. An API specifies how software components should interact. APIs are used when programming graphical user interface (GUI) components. A server-side web API is a programmatic interface consisting of one or more publicly exposed endpoints to a defined request-response message system.

The listing recommendation server 14 communicates with a real estate application 38 on the handheld device 28 through the buyer API 34 and buyer database system 18. An agent application 40 on the handheld device 30 communicates with the listing recommendation server 14 and the electronic key server 22. The buyer API 34 and the electronic key API 36 also communicate with the data center 24 through a firewall “F” or other security protocol.

The real estate application 38 may be a mobile application that may be used by the home buyer “B” to rate the properties they have seen via, for example, recordation of feedback and cataloging of the properties of interest. The real estate application 38 communicates with the buyer database system 18 through the buyer API 34 which then stores the ratings and notes taken by the home buyer in the buyer database system 18.

The agent application 40 may be a mobile application that may be used by the showing agent “R” to access the electronic key boxes 50. The electronic key API 36 communicates with the agent application 40 to sync activity from the electronic key boxes 50 to the electronic key API 36 (e.g., key boxes the key has opened), and showing notifications (e.g., messages about accessed key boxes and associated showing agent “R”).

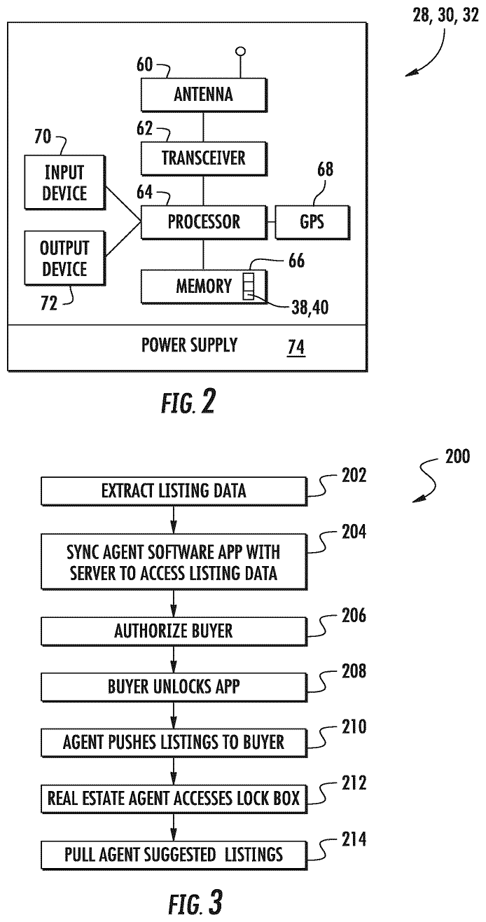

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc. The handheld device transceiver 62 is a transceiver of a type corresponding to the transceiver 62 and the handheld device antenna 60 is a corresponding antenna.

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to extract (202) MLS data from the external data servers 26A-26N into the listing recommendation server 14. Next, the agent application 40 syncs (204) with the listing recommendation server 14 and pulls MLS data for desired listings. This may be performed through an automated sync through the agent application 40. The showing agent “R” may also do a manual sync to obtain updated MLS data.

Through the agent application 40, the showing agent “R” can authorize (206) the home buyer “B” to access the desired listings of interest to the buyer “B”. Through the agent application 40, the showing agent “R” authorizes the buyer “B” through input of buyer identification information (e.g., name and email address.) The buyer identification information is then synced with the listing recommendation server 14. The listing recommendation server 14 then communicates with the buyer “B” (e.g., via email) that can include a link to an app store and a code to unlock (208) the real estate application 38. The buyer “B” is then authorized to download the real estate application 38 and desired listings, or to maintain the value of the showing agent “R” in the real estate transaction.

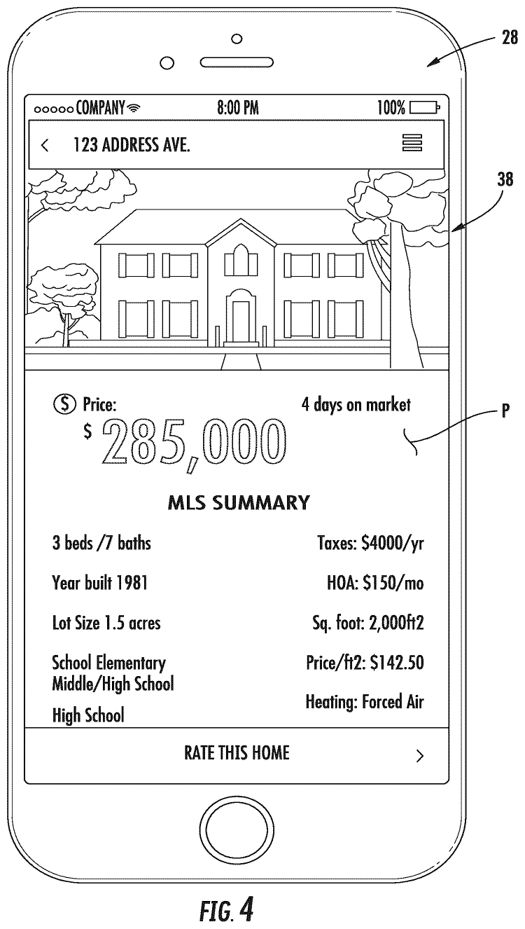

Through the agent application 40, the showing agent “R” can continue to push (210) listings to the real estate application 38. Access may be provided for one or more properties by a showing code, or other link to unlock one or more features in the real estate application 38. The showing agent “R” is able to selectively push properties (one example property illustrated by screenshot “P”; FIG. 4) to be viewable within the real estate application 38. The showing agent “R” also uses the agent application 40 to operate the electronic key box 50 to access the property for showing to the buyer “B.”

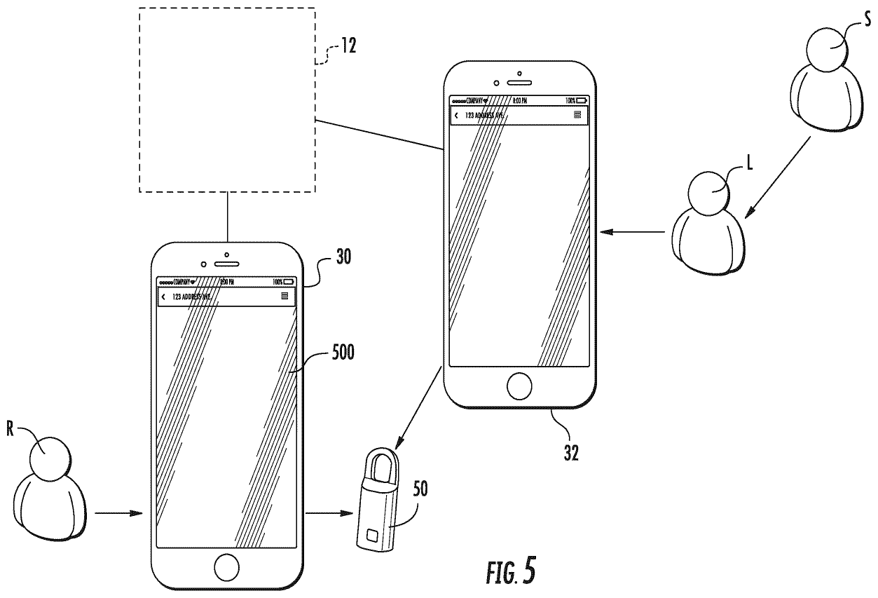

With reference to FIG. 5, in addition to the features discussed above, the showing agent “R” can utilize a data at the door application 500 to receive time sensitive information. The data at the door application 500 may be a separate application and/or a portion of the agent application 36 and/or other application.

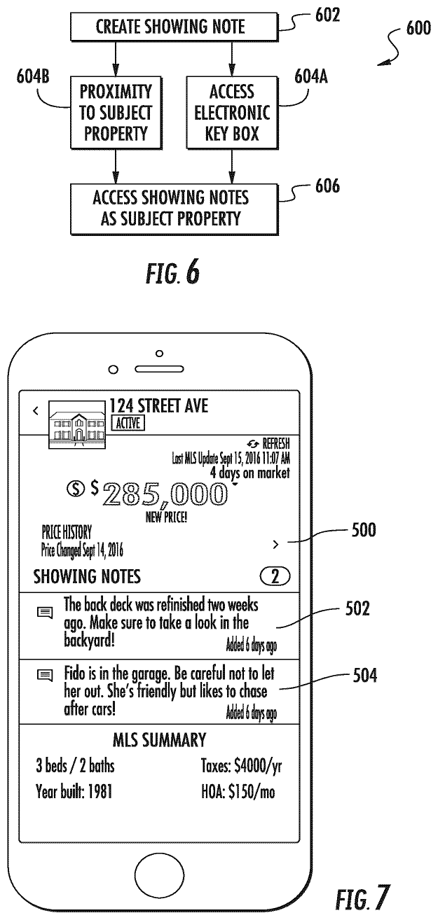

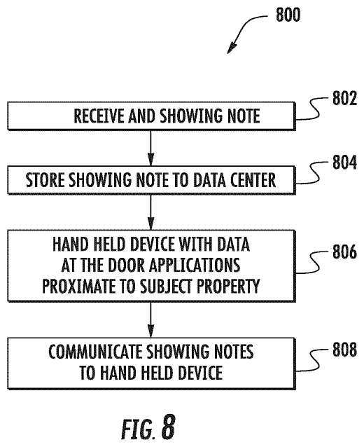

With reference to FIG. 6, a method 600 for receipt of showing notes utilizing the data at the door application 500 is illustrated in terms of functional block diagrams. Initially, at any time the listing is on the market, the showing agent “R” or the home owner can create (602) a showing note or input other data not typically in MLS data through the agent application 36. As one example, the showing note could be a home owner time sensitive showing note (e.g., the dog is in the garage; the deck has been refinished; FIG. 7). The data at the door application 500 may also provide MLS data (e.g., price changes, school districts, taxes, crime rates, etc.) as well as local attractions (shops, parks, restaurants, etc.). Various sources (e.g., internet search, dedicated attraction sources) may be utilized to populate data that is not typically provided as MLS data.

The data at the door application 500 communicates with the listing recommendation server 14 to obtain the showing notes 502, 504, as well as any other data that is not typically in MLS data but has been previously uploaded for use by the data at the door application 500. A user such as the showing agent “R” then may access the data at the door application 500 when showing the subject property. In one embodiment, the data at the door application 500 may automatically open when the showing agent “R” accesses the electronic key box 50 (604A). Alternatively, the data at the door application 500 may automatically be opened in response to a proximity (604B) to the subject property (e.g., the proximity may be determined by the GPS module 68 (FIG. 2) and the agent application 36) when the showing agent “R” comes within a predetermined distance of the subject property even prior to access of the electronic key box 50.

With reference to FIG. 8, a method 800 of operation of the data at the door application 500 is disclosed in terms of functional block diagrams. The functions are programmed software routines and executable instructions capable of execution in various microprocessor based electronic control embodiments and represented herein as block diagrams.

Initially, a showing note is received (802) for the subject property through the agent application 36 or another interface with the subsystem 12. The showing note or other information is then stored (804) to the data center 24. Then, later when a showing is essentially in progress, and in response to cither proximity to the subject property, or access to the electronic key box 50 of the subject property (806; FIG. 6), the data at the door application 500 is automatically opened and the showing data displayed (806).

The data at the door application 500 allows the showing agent “R” to have relevant information without carrying sheaves of paper information and permits home owner participation in the showing process by providing timely and up-to-date information.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed is:

1. A computer-implemented method for inter-server communication in a real estate data system, comprising:
receiving, by a processor of a listing recommendation server, a showing note regarding a subject real estate listing for a subject property, wherein the showing note includes time sensitive data that is not in an MLS listing for the subject real estate listing;
transmitting, by the listing recommendation server processor, the showing note from the listing recommendation server to a processor of a data center via a network communication protocol;
storing, by the data center processor, the showing note in the data center;
receiving, by the listing recommendation server processor, data from a processor of an electronic key server indicating that a handheld device accessed an electronic key box at the subject property;
transmitting, by the listing recommendation server processor, a data request from the listing recommendation server in response to the indication that the handheld device accessed the electronic key box at the subject property;
receiving the showing note at a processor of the handheld device from the listing recommendation server; and
displaying, through a data at the door application operating on the handheld device, the showing note on the handheld device.

2. The computer-implemented method of claim 1, further comprising receiving, by the listing recommendation server, local attractions data not provided as MLS data in proximity to the subject property from at least one external server.

3. The computer-implemented method of claim 1, wherein the showing note is received from a user input interface in communication with the listing recommendation server.

4. The computer-implemented method of claim 1, further comprising:
receiving, by the listing recommendation server processor, electronic key box access data from the processor of the electronic key server; and
transmitting, by the listing recommendation server processor, the electronic key box access data to a processor of an agent application for generating reports regarding showing activity at the subject property.

5. The computer-implemented method of claim 1, wherein the listing recommendation server is further configured to execute an analytics software application that compiles and runs analytics against the showing note and data received from the data center.

6. The computer-implemented method of claim 1, wherein the time sensitive data comprises at least one of property conditions or occupant-related notifications.

7. The computer-implemented method of claim 1, wherein the data at the door application comprises a mobile software application executed by the handheld device processor configured to display the showing note received from the listing recommendation server processor.

8. A computer-implemented method for inter-server communication in a real estate data communication system, comprising:
receiving, by a processor of a listing recommendation server, MLS data from at least one external data server, wherein the MLS data includes a plurality of property listings;
transmitting, by the listing recommendation server processor, the MLS data to a processor of an agent application;
receiving, by the listing recommendation server processor, buyer identification information of a buyer from the agent application processor;
transmitting, by the listing recommendation server processor, the buyer identification information from the listing recommendation server to a processor of a buyer database system;
storing, by the buyer database system processor, the buyer identification information in a database within the buyer database system;
generating, by the listing recommendation server processor, a communication to the buyer to unlock a real estate application in response to receipt of the buyer identification information;
receiving, by the listing recommendation server processor, property selection data from the agent application processor, wherein the property selection data includes at least one property listing;
receiving, by the buyer database system processor, buyer rating data and notes from a device operated by the buyer;
transmitting, by the buyer database system processor, the buyer rating data and notes to the listing recommendation server processor;
receiving, by the agent application processor, the buyer rating data and notes from the listing recommendation server processor.

9. The computer-implemented method of claim 8, wherein the transmitting of the MLS data to the agent application processor occurs automatically in response to receiving of the MLS data from the at least one external data server.

10. The computer-implemented method of claim 8, wherein the property selection data identifies one or more properties that the showing agent pushes to be viewable to the buyer within the real estate application, and wherein the transmission of the property selection data from the agent application processor to the listing recommendation server occurs in response to the agent's selection.

11. The computer-implemented method of claim 8, wherein the buyer identification information comprises at least one of: a name of the buyer, an email address of the buyer, and contact information for the buyer input through the agent application by a showing agent to authorize the buyer to access desired listings.

12. The computer-implemented method of claim 8, wherein the communication to the buyer comprises an email communication that includes a link to an app store and a code to unlock the real estate application.

13. The computer-implemented method of claim 8, wherein the buyer rating data and notes are transmitted from the buyer database system processor to the listing recommendation server processor through a buyer application program interface.

14. The computer-implemented method of claim 8, wherein the buyer rating data and notes stored by the buyer database system processor are accessible to the listing recommendation server processor for generating analytics reports regarding buyer preferences.

15. A real estate data communication system for inter-server communication, comprising:
a first processor of a listing recommendation server configured to:
receive a showing note regarding a subject real estate listing, wherein the showing note includes time sensitive data that is not in the MLS listing for the subject real estate listing,
receive MLS data from at least one external data server, wherein MLS data includes a plurality of property listings,
transmit the MLS data to a second processor of an agent application,
receive buyer identification information of a buyer from the second processor,
transmit the buyer identification information from the listing recommendation server to a third processor of a buyer database system,
generate a communication to the buyer to unlock a real estate application in response to receipt of the buyer identification information,
receive property selection data from the second processor, wherein the property selection data includes at least one property listing,
receive data from a fourth processor of an electronic key server indicating that a handheld device accessed an electronic key box at the subject property corresponding to the subject real estate listing,
transmit a data request from the listing recommendation server to a fifth processor of a data center in response to the indication that the handheld device accessed the electronic key box at the subject property, and
transmit the showing note from the listing recommendation server to a sixth processor of the handheld device for display in a data at the door application;
the second processor of the agent application configured to:
receive the MLS data from the first processor,
transmit the buyer identification information to the first processor,
transmit the property selection data to the first processor, and
receive buyer rating data and notes from the first processor;
the third processor of the buyer database system configured to:
receive the buyer identification information from the first processor,
store the buyer identification information in a database within the buyer database system,
receive buyer rating data and notes from a device operated by the buyer, and
transmit the buyer rating data and notes to the first processor;
the fourth processor of the electronic key server configured to:
transmit data to the first processor indicating that the handheld device accessed the electronic key box at the subject property;
the fifth processor of the data center configured to:
receive the showing note from the first processor via a network communication protocol,
store the showing note in the data center in communication with the listing recommendation server, and
receive the data request from the first processor; and
the sixth processor of the handheld device configured to:
receive the showing note from the first processor for display in a data at the door application.

16. The real estate data communication system of claim 15, wherein the first processor is further configured to:
receive local attractions data not provided as MLS data in proximity to the subject property from at least one external server; and
transmit the local attractions data to the sixth processor for display with the showing note in the data at the door application.

17. The real estate data communication system of claim 15, wherein the first processor is further configured to:
receive electronic key box access data from the fourth processor of the electronic key server; and
transmit the electronic key box access data to the second processor of the agent application for generating reports regarding showing activity at the subject property.

18. The real estate data communication system of claim 15, wherein the first processor is further configured to execute an analytics software application that compiles and runs analytics against the showing note and data received from the fifth processor of the data center.

19. The real estate data communication system of claim 15, wherein the time sensitive data comprises at least one of: temporary property conditions, occupant-related notifications, or local attractions information that are not permanently recorded in standard property listing databases.

20. The real estate data communication system of claim 15, wherein the buyer rating data and notes are transmitted from the third processor to the first processor through a buyer application programming interface, and wherein the first processor is configured to generate analytics reports regarding buyer preferences based on the buyer rating data and notes.
